(19) United States
(12) Patent Application Publication
(10) Pub. No.: US 2014/0242852 A1
(43) Pub. Date: Aug. 28, 2014

(54) WATERPROOF CONNECTOR

(71) Applicant: YAZAKI CORPORATION, Tokyo (JP)

(72) Inventor: Yoshimi MATSUI, Makinohara-shi (JP)

(73) Assignee: YAZAKI CORPORATION, Tokyo (JP)

(21) Appl. No.: 14/185,441

(22) Filed: Feb. 20, 2014

(30) Foreign Application Priority Data
Feb. 22, 2013 (JP) 2013-033735

(51) Int. Cl. H01R 13/52

(52) U.S. Cl. CPC H01R 13/5202
USPC 439/730

(57) ABSTRACT

A waterproof connector includes a terminal fitting, a connector housing, a rubber plug, and a cap. The terminal fitting includes a tubular main body, a core wire crimping portion which is crimped to a core wire of an electric wire, and an insulation sheath crimping portion which is crimped to an insulation sheath of the electric wire. The connector housing has a terminal containing portion which contains the terminal fitting. The rubber plug is fitted onto the insulation sheath of the electric wire, and is pressingly inserted into the terminal containing portion. The cap is fitted onto the core wire crimping portion, and which is made of resin or rubber.

### BACKGROUND

The present invention relates to a waterproof connector.

FIG. 12 is a sectional view of a waterproof connector disclosed in Patent Document 1 below. The waterproof connector includes: a connector housing 110; a female terminal fitting 130 which is mounted in the interior of the connector housing 110, and to which an electric wire 190 is connected; a resin-made stopper 170 which is mounted on a connecting portion 133 between the female terminal fitting 130 and the electric wire 190; a rubber plug 180 which is fitted onto the outer periphery of the electric wire 190; and a sealant 160 which fills the gap between the stopper 170 and the rubber plug 180. The stopper 170 is configured by mold-covering the periphery of the connecting portion 133 with a resin material.

In a process of producing the connector disclosed in JP-A-2012-59624, however, an insert molding apparatus for forming the stopper 170, and a sealant filling apparatus for filling the interior of the connector housing with the sealant are necessary, thereby causing a problem in that the production process to be complicated. Since the production process is complicated, there arises a further problem in that the productivity of the waterproof connector is low.

### SUMMARY

Therefore, it is an object of the invention to solve the above-discussed problems, and provide a waterproof connector in which a waterproof structure can be easily formed, and the productivity can be enhanced.

The object of the invention can be achieved by the following configurations.

(1) A waterproof connector including:

a terminal fitting including:
a tubular main body;
a core wire crimping portion which is placed in a rear part of the main body portion, and which is crimped to a core wire of an electric wire; and
an insulation sheath crimping portion which is placed in rear of the core wire crimping portion on the main body part, and which is crimped to an insulation sheath of the electric wire;

a connector housing having a terminal containing portion which contains the terminal fitting;

a rubber plug which is fitted onto the insulation sheath of the electric wire, and which is pressingly inserted into the terminal containing portion; and

a cap which is fitted onto the core wire crimping portion, and which is made of resin or rubber.

(2) For example, the cap is formed by a water swellable rubber material.

(3) For example, the cap has a leg portion which is passed through a stabilizer passage formed in the connector housing.

(4) For example, a guide groove is formed on the cap, and the terminal containing portion has a projecting portion which is guided in the guide groove.

(5) For example, a part of the cap is formed into a stepped shape.

According to the configuration of the item (1), the connector includes the cap which is fitted onto the core wire crimping portion of the terminal fitting, and hence the terminal fitting in the connector housing is covered by the cap. Even when water enters through a tip end opening of the connector housing, therefore, the entering water is surely blocked by the cap. Consequently, a water proof effect is surely attained. Since the core crimping portion of the terminal fitting is surely water proofed, electrolytic corrosion can be surely prevented from occurring in the core wire crimping portion. Moreover, the configuration can be formed simply by adding a simple component or the cap which is fitted onto the core wire crimping portion. Therefore, the waterproof structure can be easily formed, and the productivity of the waterproof connector can be enhanced.

According to the configuration of the item (2), the cap is formed by a water swellable rubber material, and, when water entering the connector housing reaches the cap, therefore, the cap is impregnated with water to swell. Therefore, the pressure contact force acting between the inner surface of the connector housing and the terminal is increased, and the waterproof property is improved. Even when the cap is inaccurately formed in a slightly reduced size, it is impregnated with entering water to swell, so that it is surely pressingly contacted with the inner surface of the connector housing and the terminal, and therefore it is possible to obtain a sure waterproof property.

According to the configuration of the item (3), the cap has the leg portion which is passed through the stabilizer passage of the connector housing, and hence the cap can be inserted and attached stably and surely into the connector housing while using the configuration of a conventional connector housing.

According to the waterproof connector of the invention, a sure waterproof structure in the core wire crimping portion can be realized by using the simple configuration, and the productivity of the waterproof connector can be improved.

In the above, the invention has been briefly described. When modes (hereinafter, referred to as “embodiments”) for carrying out the invention which will be described below are read with reference to the accompanying drawings, the detail of the invention will be further clarified.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1A is a longitudinal sectional view of an embodiment of the waterproof connector of the invention, FIG. 1B is an A-A sectional view of the waterproof connector in FIG. 1A, and FIG. 1C is a B-B sectional view of the waterproof connector in FIG. 1A.

FIG. 2A is a side view of a state where a rubber plug and a cap are mounted on a terminal fitting, FIG. 2B shows C-C, D-D, and E-E sectional views of the terminal fitting in FIG. 2A in a state that a terminal exists, and FIG. 2C shows C-C, D-D, and E-E sectional views of the terminal fitting in FIG. 2A in a state that a terminal does not exist.

FIG. 3 is a perspective view of the cap.

FIG. 4 is a perspective view of the rubber plug.

FIG. 5 is a perspective view of the state where the rubber plug and the cap are mounted on the terminal fitting.

FIG. 6 is a longitudinal sectional view of a second embodiment of the waterproof connector of the invention.

FIG. 7 is a perspective view of a cap in the second embodiment.

FIG. 8 is a perspective view of a rubber plug in the second embodiment.

FIG. 9 is a longitudinal sectional view of a third embodiment of the waterproof connector of the invention.

FIG. 10 is a perspective view of a cap in the third embodiment.

FIG. 11 is a perspective view of a rubber plug in the third embodiment.

FIG. 12 is a sectional view of a conventional waterproof connector.

### DETAILED DESCRIPTION OF EXEMPLARY EMBODIMENTS

Hereinafter, preferred embodiments of the waterproof connector of the invention will be described in detail with reference to the drawings. In the following description, the tip end side of a terminal fitting is referred to as the front side, and a wire-connecting side of the terminal fitting is referred to as the rear side.

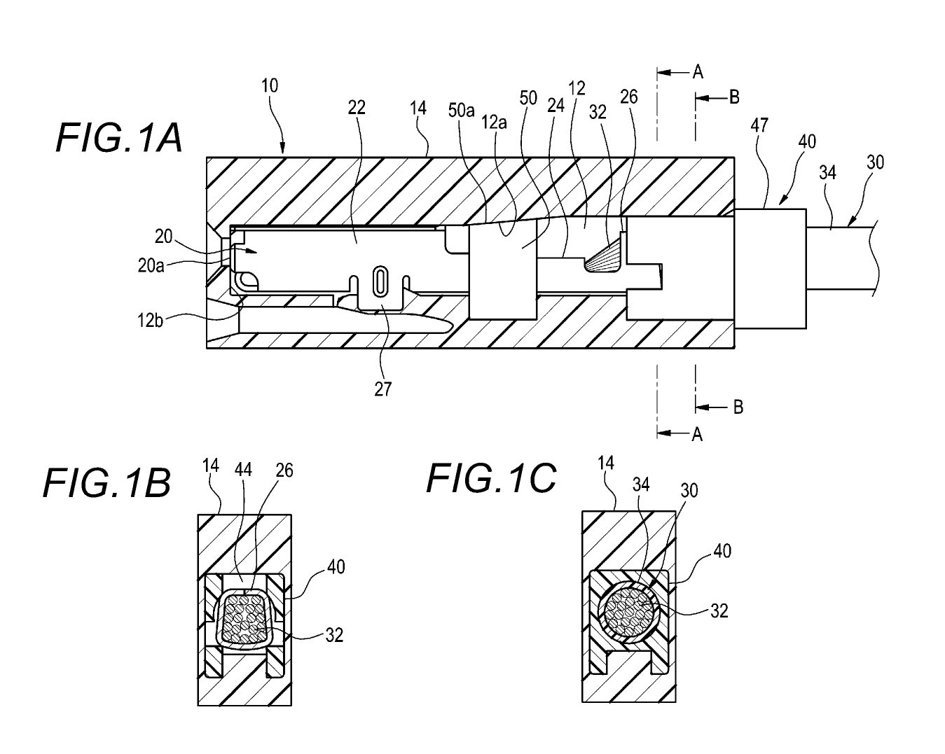

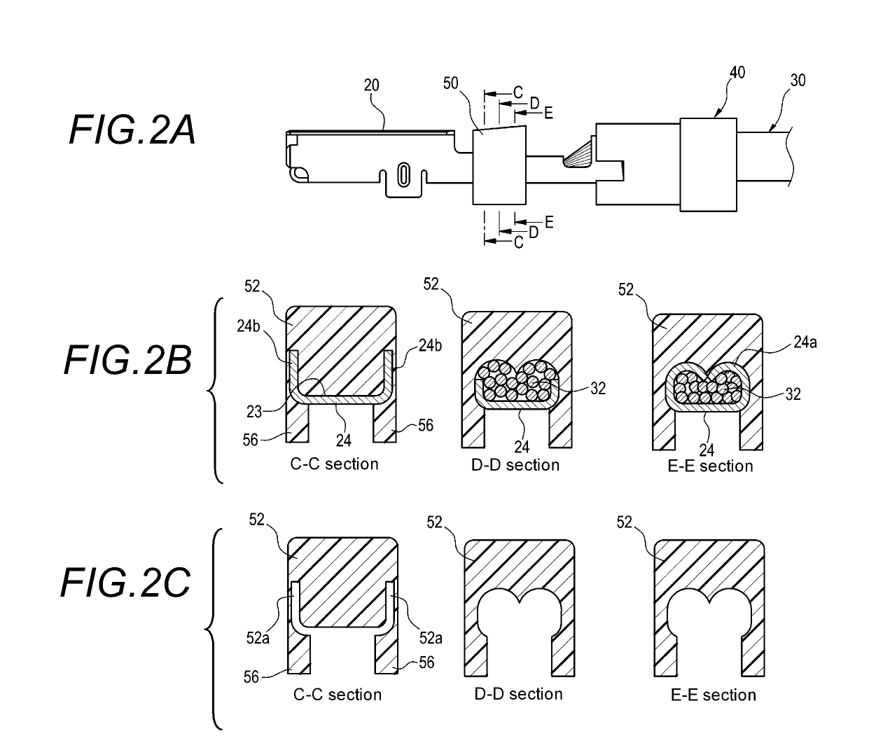

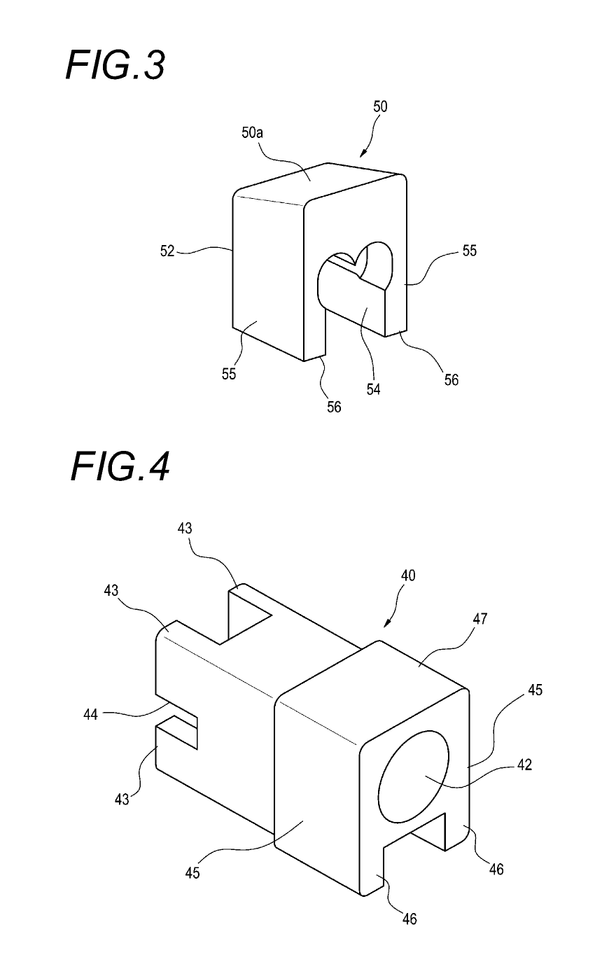

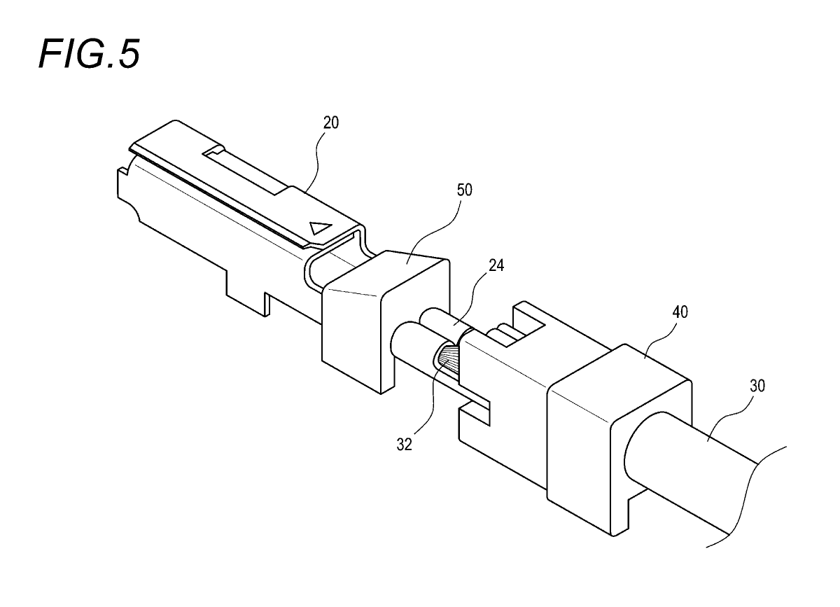

FIG. 1A is a longitudinal sectional view of an embodiment of the waterproof connector of the invention, FIG. 1B is an A-A sectional view of FIG. 1A, FIG. 1C is a B-B sectional view of FIG. 1A, FIG. 2A is a side view of a state where a rubber plug and a cap are mounted on a terminal fitting, FIG. 2B shows C-C, D-D, and E-E sectional views of the terminal fitting in FIG. 2A in a state that a terminal exists, and FIG. 2C shows C-C, D-D, and E-E sectional views of the terminal fitting in FIG. 2A in a state that a terminal does not exist, FIG. 3 is a perspective view of the cap, FIG. 4 is a perspective view of the rubber plug, and FIG. 5 is a perspective view of the state where the rubber plug and the cap are attached to the terminal fitting.

### First Embodiment

The waterproof connector 10 includes: a female terminal fitting 20 including: a tubular main body 22; a core wire crimping portion 24 which is placed in rear of the main body portion 22, and which is to be crimped to a core wire 32 of an electric wire 30; and an insulation sheath crimping portion 26 which is placed in rear of the core wire crimping portion 24, and which is to be crimped to an insulation sheath 34 of the electric wire 30; a connector housing 14 having a terminal containing portion 12 which contains the female terminal fitting 20; a rubber plug 40 which is to be fitted onto the insulation sheath 34 of the electric wire 30, and which is pressingly inserted into the terminal containing portion 24; and a cap 50 which is fitted onto the core wire crimping portion 24, and which is made of a resin or rubber.

The terminal containing portion 12 is formed in the connector housing 14, and the female terminal fitting 20 to which the electric wire 30 is connected is housed in the terminal containing portion 12. The cap 50 which is fitted onto the core wire crimping portion 24, and the rubber plug 40 which is fitted onto the insulation sheath crimping portion 26 are mounted on the female terminal fitting 20.

As shown in FIG. 5, the cap 50 and the rubber plug 40 are mounted on the female terminal fitting 20 while being fitted onto the terminal which is connected to the electric wire 30, and inserted into the terminal containing portion 12 of the connector housing 14.

As shown in FIG. 3, the cap 50 has a recess 54 which opens in the rear and lower sides, and which has a shape substantially identical with the core wire crimping portion 24, and a wall portion 52 in the front side. Leg portions 56 which extend downwardly more than the core wire crimping portion 24 are formed on the side walls 55 of the cap 50, respectively. The external shape of the upper portion of the cap 50 is substantially same as the shape of the inner peripheral surface which is opposed to the core wire crimping portion 24 in the terminal containing portion 12.

As shown in FIG. 1A, the upper surface 50a of the cap 50 is formed into an inclined surface which is downwardly inclined toward the tip end. In the connector housing 14, also the surface of the terminal containing portion 12 which is opposed to the cap 50 is formed into a similar inclined surface 12a. When the female terminal fitting 20 is inserted into the terminal containing portion 12, therefore, the cap 50 receives a downward force, and hence is satisfactorily pressingly contacted with the core wire crimping portion 24.

As shown in FIGS. 2B and 2C, the front side of the cap 50 is configured so as to be closed by the wall portion 52, and the lower surface of the wall portion 52 is in contact with the bottom surface 23 of the female terminal fitting 20. In the wall portion 52, a pair of slits 52a are formed through which the side walls 24b in the portions of the core wire crimping portion 24 on which the core wire 32 is not placed are passed, respectively. According to the configuration, the leg portions 56 can be deformed toward the outside. Then, the cap 50 is fitted onto the core wire crimping portion 24 so that the core wire crimping portion 24 is accommodated in the recess 54.

The E-E section in FIG. 2B shows a portion in which the core wire 32 is crimped by core wire crimping pieces 24a. The D-D section in FIG. 2B shows a portion which is in front of that where the core wire 32 is crimped, and in which the core wire crimping pieces 24a do not exist. The C-C section in FIG. 2B shows a portion in which the core wire 32 is not placed. Namely, the tip end of the core wire 32 is located between the D-D section and the C-C section, and not exposed on the front side of the connector. According to the configuration, water which enters through the front side of the connector does not reach the core wire 32 while creeping on the bottom surface 23 of the female terminal fitting 20. Therefore, electrolytic corrosion can be surely prevented from occurring in the core wire crimping portion 24.

As shown in FIG. 4, the rubber plug 40 has a hole 42 into which the insulation sheath crimping portion 26 is pressingly inserted. As shown in FIGS. 1B and 4, the front side of the rubber plug 40 is circumferentially divided into a plurality of portions by cut outs 44. Leg portions 46 which are similar to those of the cap 50 are formed on the side walls 45 of the rubber plug 40, respectively. Since the front side of the rubber plug 40 is divided into the plurality of portions by the cut outs 44, the divided portions can be independently deformed, and therefore the insulation sheath crimping portion 26 can be surely held.

The rubber plug 40 is formed to have an external shape which is slightly larger than the size of the terminal containing portion 12, and, when the female terminal fitting 20 is inserted into the terminal containing portion 12, the rubber plug 40 is pressingly contacted with the inner peripheral surface of the terminal containing portion 12. Therefore, the waterproof property is attained in the rear end side of the connector. The rear end side of the rubber plug 40 is formed into a stepped shape having an external shape which is larger than the portion that is pressingly inserted into the terminal containing portion 12. A rear end portion 47 by which the stepped shape is formed has an external shape which is larger than the terminal containing portion 12, so that the boundary between the terminal containing portion 12 and the rubber plug 40 is not exposed to the outside. According to the configuration, the waterproof property in the rear end side of the connector is further enhanced.

The rubber plug 40 may not have a stepped shape such as described above, and may have a straight shape. The size of the rubber plug 40 may be substantially identical with that of the terminal containing portion 12.

In order to mount the female terminal fitting 20 in the waterproof connector 10, the female terminal fitting 20 to which the cap 50 and the rubber plug 40 are mounted is inserted into the terminal containing portion 12 from the rear side of the connector housing 14. In the connector housing 14, grooves (not shown) in which stabilizers 27 formed in the female terminal fitting 20 are to be moved are formed. With increasing insertion of the female terminal fitting 20 after the stabilizers 27 are put in the grooves, also the cap 50 and the rubber plug 40 are moved into the terminal containing portion 12. At this time, the leg portions 56 of the cap 50 are moved in the grooves for the stabilizers 27, and therefore the cap 50 can be stably moved. Then, the cap 50 is guided by the inclined surface 12a of the upper portion of the inner surface of the terminal containing portion 12 to receive a downward force, and hence pressingly contacted with the core wire crimping portion 24. The rubber plug 40 is pressingly inserted into the terminal containing portion 12. When the tip end 20a of the female terminal fitting 20 butts against a tip-end receiving part of the terminal containing portion 12, the attachment of the female terminal fitting 20 is completed.

The cap 50 is molded with a resin or rubber. In the case where the cap 50 is molded with a resin, the material which is identical with that of the connector housing 14 may be used.

In the case where the cap 50 is molded with rubber, a water swellable rubber seal material may be used. An example of a useful water swellable rubber sealing material is AQUAQUELL (trade name) manufactured by OHJI RUBBER CHEMICAL CO., LTD.

In the case where the cap 50 is molded with a water swellable rubber sealing material, the molding may be performed with an accuracy which is not high, and the cap may be molded in a slightly smaller size because of the following reason. Even in the case where a small gap exists between the cap 50 mounted on the terminal containing portion 12, and the female terminal fitting 20, when water entering from the outside contacts with the wall portion 52 in the front side of the cap 50, the cap 50 swells, and the gap between the cap and the female terminal fitting 20 disappears.

The first embodiment described above includes the cap 50 which is fitted onto the core wire crimping portion 24 of the female terminal fitting 20. Therefore, it is possible to surely block water from entering the core wire crimping portion 24, and electrolytic corrosion can be surely prevented from occurring in the core wire crimping portion 24. Moreover, the configuration can be formed simply by adding a simple component or the cap 50, and therefore the productivity of the waterproof connector 10 can be enhanced.

### Second Embodiment

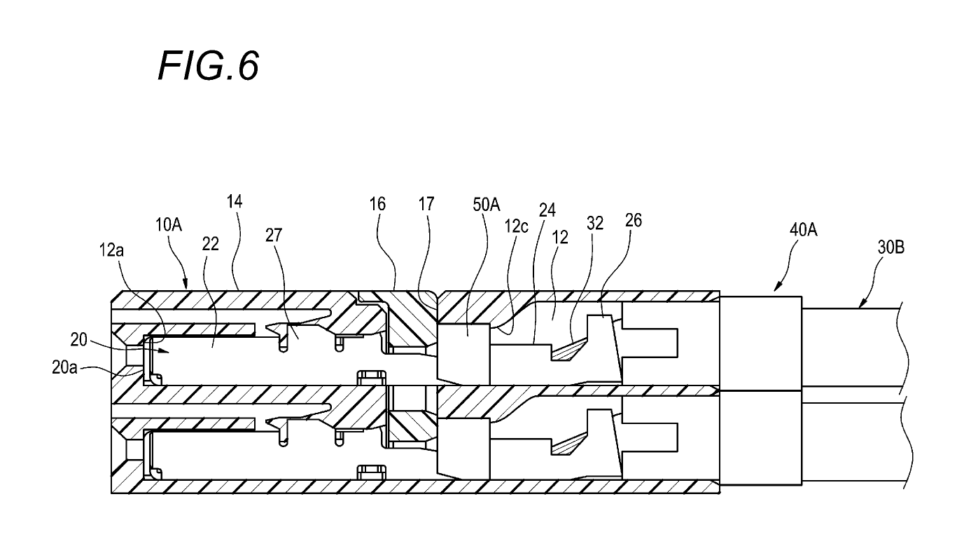

Next, a second embodiment of the waterproof connector of the invention will be described with reference to FIGS. 6 to 8. The second embodiment differs from the first embodiment only in that the waterproof connector 10A has a double engagement structure, and that the shapes of caps 50A and rubber plugs 40A are different from those of the first embodiment. Therefore, the components which are identical with those of the first embodiment are denoted by the same reference numerals, and their description will be omitted or simplified.

The waterproof connector 10A of the second embodiment is configured so that, after all female terminal fittings 20 are mounted on the connector housing 14, a double engagement member 16 is attached to a double engagement hole 17 of the connector housing 14, thereby surely preventing the female terminal fittings 20 from slipping off.

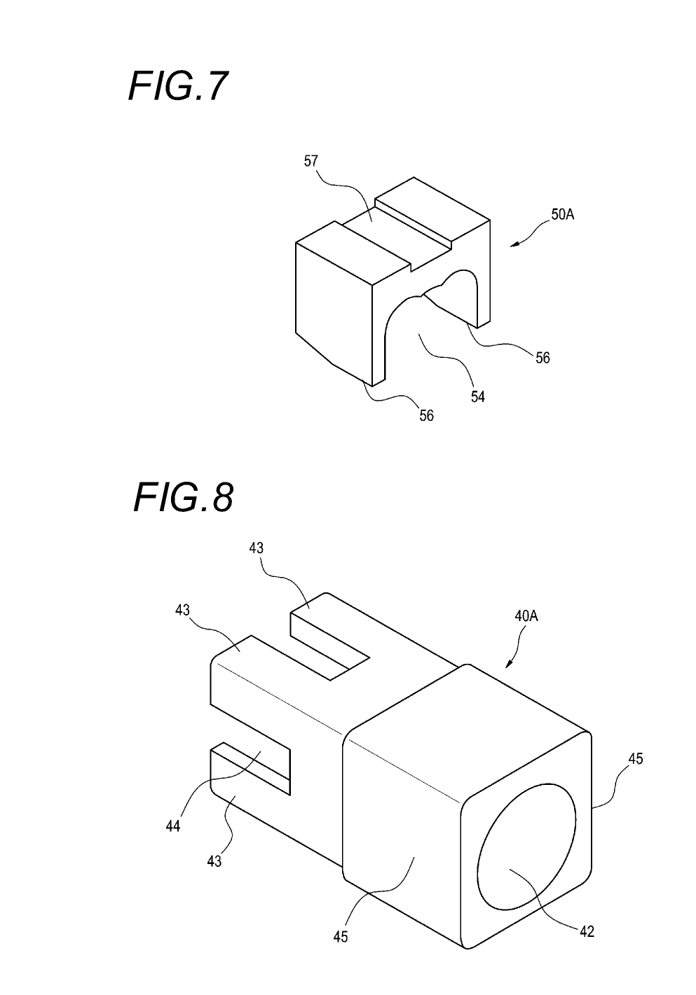

As shown in FIG. 6, projecting portions 12c which are downward projected are formed on the upper surfaces of the terminal containing portions 12, respectively. On the other hand, as shown in FIG. 7, grooves 57 through which the projecting portions 12c is passed are formed in the upper surfaces of the caps 50A, respectively. When the respective cap 50A which is fitted onto the core wire crimping portion 24 of the corresponding female terminal fitting 20 is inserted into one of the terminal containing portions 12, the projecting portion 12c of the terminal containing portion 12 is passed through the groove 57 formed in the upper surface of the cap 50A, whereby the cap 50A is successfully guided.

Unlike the first embodiment, the leg portions 46 are not formed on the rubber plug 40A as shown in FIG. 8.

Also according to the second embodiment, effects which are similar to those of the first embodiment are attained.

### Third Embodiment

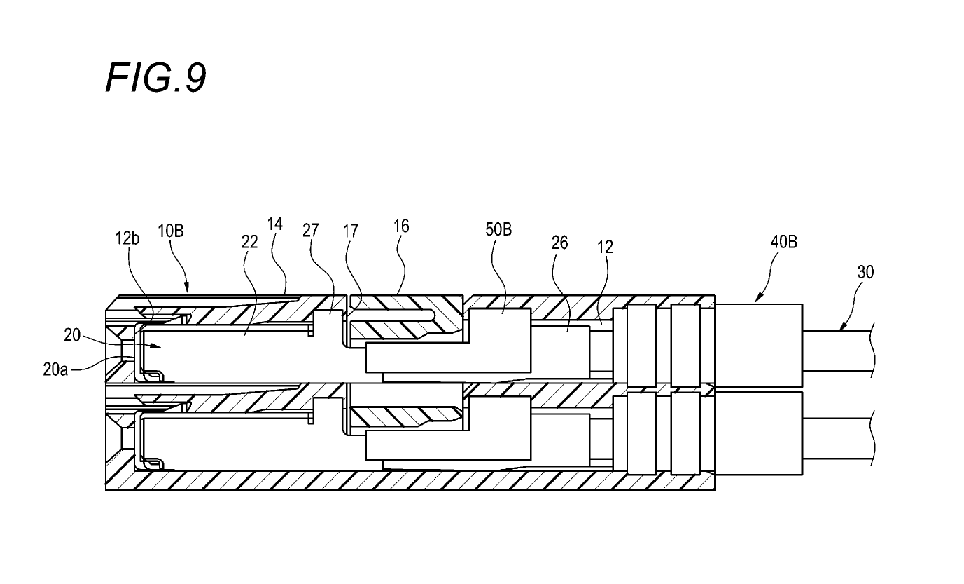

Next, a third embodiment of the waterproof connector of the invention will be described with reference to FIGS. 9 to 11. The third embodiment differs from the first embodiment only in that the waterproof connector 10B has a double engagement structure, and that the shapes of caps 50B and rubber plugs 40B are different from those of the first embodiment. Therefore, the components which are identical with those of the first embodiment are denoted by the same reference numerals, and their description will be omitted or simplified.

Also the waterproof connector 10B of the third embodiment is configured so that, after all female terminal fittings 20 are mounted in the connector housing 14, a double engagement member 16 is attached to a double engagement hole 17 of the connector housing, thereby surely preventing the female terminal fittings 20 from slipping off.

In the third embodiment, each of the caps 50B is formed so that only the leg portions 56 are formed to be longer in the longitudinal direction than those of the caps 50, 50A of the first and second embodiments. The cap 50B is formed into a shape where it is fitted onto both the insulation sheath crimping portion 26 and the core wire crimping portion 24.

Also according to the third embodiment, effects which are similar to those of the first embodiment are attained.

According to the third embodiment, moreover, both the core wire crimping portion 24 and the insulation sheath crimping portion 26 can be surely water proofed by the cap 50B, and electrolytic corrosion can be surely prevented from occurring in the core wire 32.

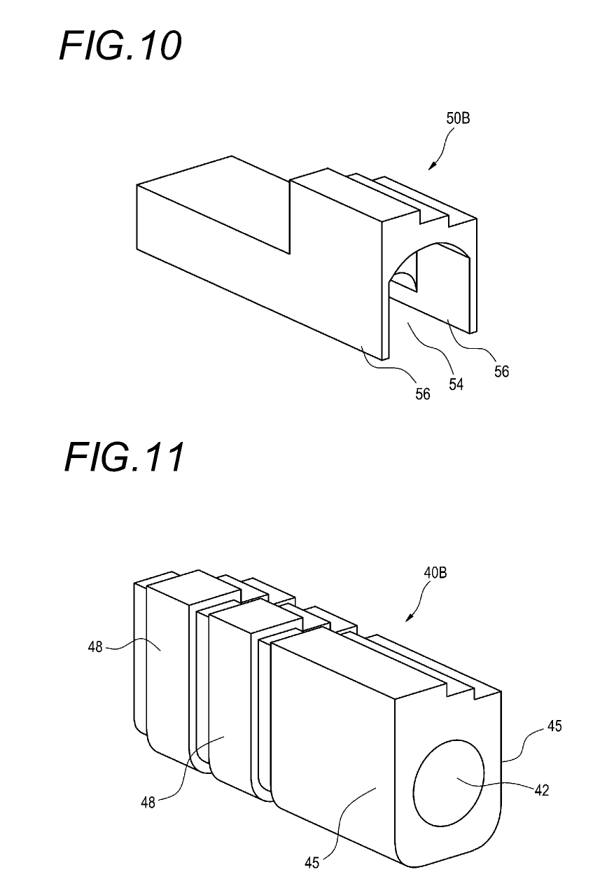

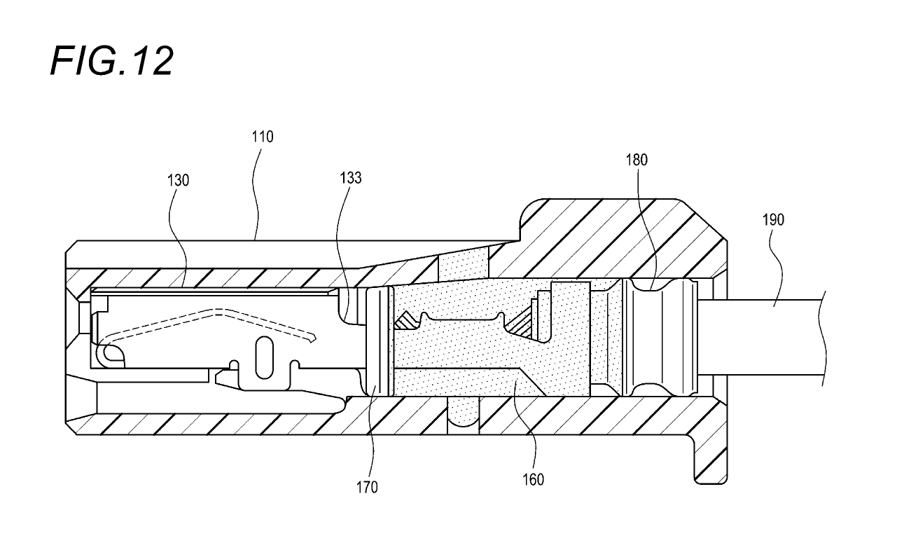

As shown in FIG. 10, a part of the cap 50B is formed into a stepped shape. As shown in FIG. 11, also a part of the rubber plug 40B is formed into a stepped shape. According to the configuration, the cap 50B and rubber plug 40B which are mounted on the connector housing 14 can be prevented from being twisted, and the waterproof property is not lowered.

As shown in FIG. 11, two ribs 48 are formed on the rubber plug 40B, and therefore the close contact property with the terminal containing portion 12 is improved.

Since the core wire crimping portion 24 is located in the portion corresponding to the double engagement hole 17 of the connector housing 14, there is a possibility that water may enter the core wire crimping portion 24 through the double engagement structure. Also in the double engagement structure, however, the cap 50B is fitted onto the core wire crimping portion 24. Therefore, it possible to surely prevent water from entering the core wire crimping portion 24, and hence electrolytic corrosion can be surely prevented from occurring in the core wire crimping portion 24.

In the connector including the double engagement member 16, water may easily enter the terminal containing portion 12, but the water can be effectively blocked by the cap 50A or 50B.

The invention is not limited to the above-described embodiments, and may be adequately subjected to modifications, improvements, and the like. In addition, the materials, shapes, dimensions, numbers, places, and the like of the components of the above-described embodiments are arbitrary and not limited insofar as the invention is achieved.

For example, the terminal fitting may be a male terminal fitting.

Features of the above-described embodiments of the waterproof connector of the invention are listed in [1] to [3] below in a brief and summarized manner.

[1] The waterproof connector (10) comprising:

a terminal fitting (20) including: the tubular main body (22); the core wire crimping portion (24) which is placed in rear of the main body portion (22), and which is crimped to the core wire (32) of the electric wire (30); and the insulation sheath crimping portion (26) which is placed in rear of the core wire crimping portion (24), and which is crimped to the insulation sheath (34) of the electric wire (30);

a connector housing (14) having the terminal containing portion (12) which contains the terminal fitting (20);

a rubber plug (40) which is fitted onto the insulation sheath (34) of the electric wire (30), and which is pressingly inserted into the terminal containing portion (12); and

a cap (50) which is fitted onto the core wire crimping portion (24), and which is made of resin or rubber.

[2] The waterproof connector (10) according to the item [1], wherein the cap (50) is formed by a water swellable rubber material.

[3] The waterproof connector according to the item [1] or [2], wherein the cap (50) has the leg portion (56) which is passed through the stabilizer passage formed in the connector housing (14).

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2013-033735 filed on Feb. 22, 2013, the contents of which are incorporated herein by reference.

What is claimed is:

1. A waterproof connector comprising:
a terminal fitting including:
a tubular main body;
a core wire crimping portion which is placed in a rear part of the main body portion, and which is crimped to a core wire of an electric wire; and
an insulation sheath crimping portion which is placed in rear of the core wire crimping portion on the main body part, and which is crimped to an insulation sheath of the electric wire;
a connector housing having a terminal containing portion which contains the terminal fitting;
a rubber plug which is fitted onto the insulation sheath of the electric wire, and which is pressingly inserted into the terminal containing portion; and
a cap which is fitted onto the core wire crimping portion, and which is made of resin or rubber.

2. The waterproof connector according to claim 1, wherein the cap is formed by a water swellable rubber material.

3. The waterproof connector according to claim 1, wherein the cap has a leg portion which is passed through a stabilizer passage formed in the connector housing.
